(19) United States
(12) Patent Application Publication
(10) Pub. No.: US 2003/0020750 A1
(43) Pub. Date: Jan. 30, 2003

(54) Specifying messaging session subject preferences

(75) Inventors: Michael Wayne Brown, Georgetown, TX (US); Rabindranath Dutta, Austin, TX (US); Michael A. Paolini, Austin, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation, Armonk, NY

(21) Appl. No.: 09/915,450

(22) Filed: Jul. 26, 2001

(51) Int. Cl. G06F 13/00; G06F 3/00

(52) U.S. Cl. 345/752; 345/745

(57) ABSTRACT

A method, system and program for notifying a user of subject preferences across multiple messaging sessions in an electronic system are provided. Multiple current messaging sessions are filtered according to subject preferences for a user. The user is then notified of a selection from among the current messaging sessions correlating to subject preferences for the user, such that the user is enabled to monitor conversations comprising the subject preferences across multiple messaging sessions. In addition, the user may be separately notified of activity levels associated with subject preferences for the user.

### CROSS-REFERENCE TO RELATED APPLICATIONS

The present application is related to the following copending applications, which are filed on even date herewith and incorporated herein by reference:

(1) U.S. patent application Ser. No. ______ (Attorney Docket No. AUS920010391US1);

(2) U.S. patent application Ser. No. ______ (Attorney Docket No. AUS920010392US1);

(3) U.S. patent application Ser. No. ______ (Attorney Docket No. AUS920010393US1);

(4) U.S. patent application Ser. No. ______ (Attorney Docket No. AUS920010394US1);

(5) U.S. patent application Ser. No. ______ (Attorney Docket No. AUS920010396US1);

(6) U.S. patent application Ser. No. ______(Attorney Docket No. AUS920010397US1); and

(7) U.S. patent application Ser. No. ______ (Attorney Docket No. AUS920010528US1).

### BACKGROUND OF THE INVENTION

1. Technical Field

The present invention relates in general to electronic communications and, in particular, to specifying messaging session subject preferences. Still more particularly, the present invention relates to alerting a user when current messaging sessions contain subjects preferred by the user and providing the user with an activity level associated with messaging sessions containing subjects preferred by the user.

2. Description of the Related Art

As the Internet and telephony expand, the ease of communications between individuals in different locations continues to expand as well. One type of electronic communication is supported by messaging which includes the use of computer systems and data communication equipment to convey messages from one person to another, as by e-mail, voice mail, unified messaging, instant messaging, or fax.

While electronic mail (e-mail) has already expanded into nearly every facet of the business world, other types of continue to forge into use. For example, instant messaging systems are typically utilized in the context of an Internet-supported application that transfers text between multiple Internet users in real time.

In particular, the Internet Relay Chat (IRC) service is one example of instant messaging that enables an Internet user to participate in an on-line conversation in real time with other users. An IRC channel, maintained by an IRC server, transmits the text typed by each user who has joined the channel to the other users who have joined the channel. An IRC client shows the names of the currently active channels, enables the user to join a channel, and then displays the other channel participant's words on individual lines so that the user can respond.

Similar to IRC, chat rooms are often available through online services and provide a data communication channel that links computers and permits users to converse by sending text messages to one another in real-time.

In current instant messaging systems, multiple topics of conversation may take place within a single channel, particularly where the channel is designated for a broad subject. This can occur easily where, for example, multiple users select a particular channel that is designated for discussion of movies and a discussion begins about a first movie. Then, as additional users enter the channel or current users want to move onto discussion of a second movie, discussions of the first and second movie may intermingle in a single thread of conversation.

As more and more subjects are discussed within a single channel, it typically becomes increasingly more difficult to follow comments being made. In addition, as more subjects are discussed within a single channel, it becomes increasing more difficult for a user to select a channel with subjects of interest to the user where those subjects are not readily identified.

Further, some channels may be utilized more often than others, however a user must open each channel to view the activity therein. Where a user would preferably like to follow multiple channels, current messaging systems are limited in that a user must actively open each channel in order to view the current message entries.

In view of the foregoing, it would be advantageous to provide a method, system and program for allowing users to specify subject preferences such that when a conversation thread about a subject preferences in a messaging session is initiated or in progress, a user is notified of that channel, topic and message entry. In addition, it would be advantageous to provide a method, system and program for providing indicators of the activity level of channels and topics including subject preferences of a user.

### SUMMARY OF THE INVENTION

In view of the foregoing, it is therefore an object of the present invention to provide an improved method, system and program for performing electronic communications.

It is another object of the present invention to provide a method, system and program for specifying messaging session subject preferences.

It is yet another object of the present invention to provide a method, system and program for alerting a user when current messaging sessions contain subjects preferred by the user and providing the user with an activity level associated with messaging sessions containing subjects preferred by the user.

According to one aspect of the present invention, multiple current messaging sessions are filtered according to subject preferences for a user. The user is then notified of a selection from among the current messaging sessions correlating to subject preferences for the user, such that the user is enabled to monitor conversations comprising the subject preferences across multiple messaging sessions. In addition, the user may be separately notified of activity levels associated with subject preferences for the user.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of a computer system with which the method, system and program of the present invention may advantageously be utilized;

FIG. 2 illustrates a simplified block diagram of a client/server environment in which electronic messaging typically takes place in accordance with the method, system and program of the present invention;

FIG. 3 depicts a block diagram of one embodiment of a messaging server in accordance with the method, system and program of the present invention;

FIG. 4 illustrates a graphical representation of a subject preference interface in accordance with the method, system and program of the present invention;

FIG. 5 depicts a graphical representation of multiple messaging session windows and current preferred subjects in accordance with the method, system and program of the present invention;

FIG. 6 illustrates a high level logic flowchart of a process and program for notifying users when messaging sessions include subject preferences in accordance with the method, system, and program of the present invention; and

FIG. 7 depicts a high level logic flowchart of the process and program for detecting and distributing activity level notifications in accordance with the method, system, and program of the present invention.

### DESCRIPTION OF THE PREFERRED EMBODIMENT

A method, system and program for enabling users to specify subject preferences and then alerting those users when messaging sessions containing subject preferences are initiated or in progress are provided. In addition, the method, system and program provide indicators to the user of the activity levels of messaging sessions containing subject preferences preferred by the user. In the present invention, “subject preferences” preferably refers to a subject matter that is typically referred to by a textual word or words, however may also include audible signals and graphical representations of a subject matter. Subjects defined within a user's subject preferences may be referenced by a channel, topic, message entry or other user.

A “messaging session” preferably includes, but is not limited to, any combination of voice, graphical, video, and/or text messages, instant and/or delayed, transmitted between multiple users via a network. Messaging sessions may include use of chat rooms, instant messages, e-mail, IRC, conference calling and other network methods of providing a channel for users to communicate within. Further, messaging sessions may include communications such as voice, video, and text transmissions between multiple telephony devices.

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### Hardware Overview

The present invention may be executed in a variety of systems, including a variety of computing systems and electronic devices under a number of different operating systems. In one embodiment of the present invention, the messaging system is a portable computing system such as a notebook computer, a palmtop computer, a personal digital assistant, a telephone or other electronic computing system that may also incorporate communications features that provide for telephony, enhanced telephony, messaging and information services. However, the messaging system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

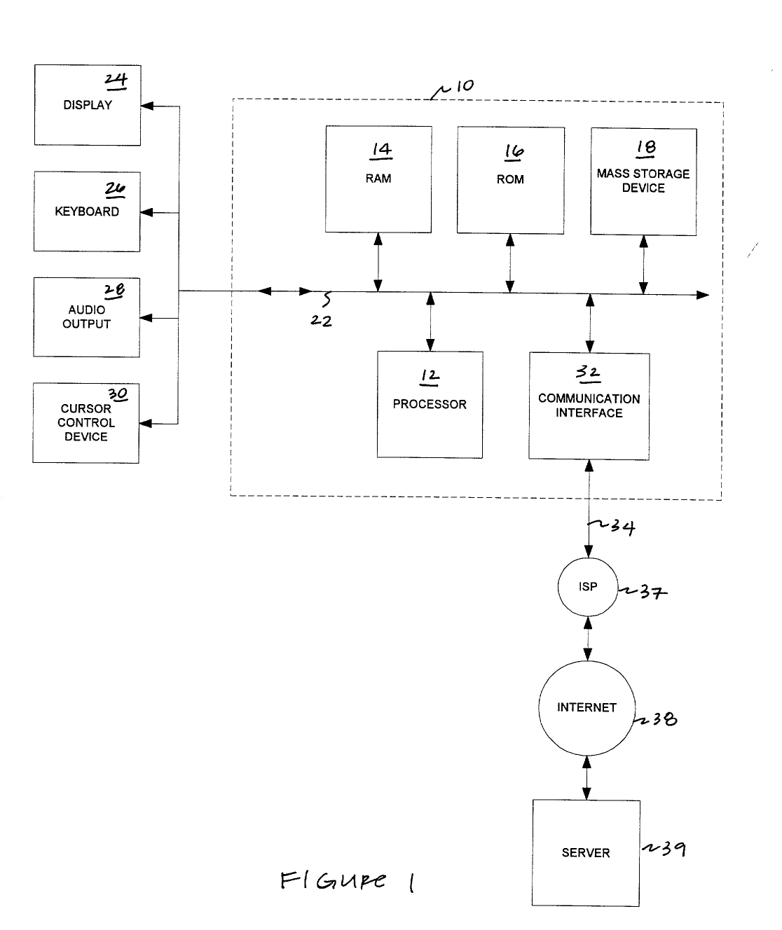

Referring now to the drawings and in particular to FIG. 1, there is depicted one embodiment of a computer system with which the method, system and program of the present invention may advantageously be utilized. Computer system 10 comprises a bus 22 or other communication device for communicating information within computer system 10, and at least one processing device such as processor 12, coupled to bus 22 for processing information. Bus 22 preferably includes low-latency and high-latency paths that are connected by bridges and controlled within computer system 10 by multiple bus controllers.

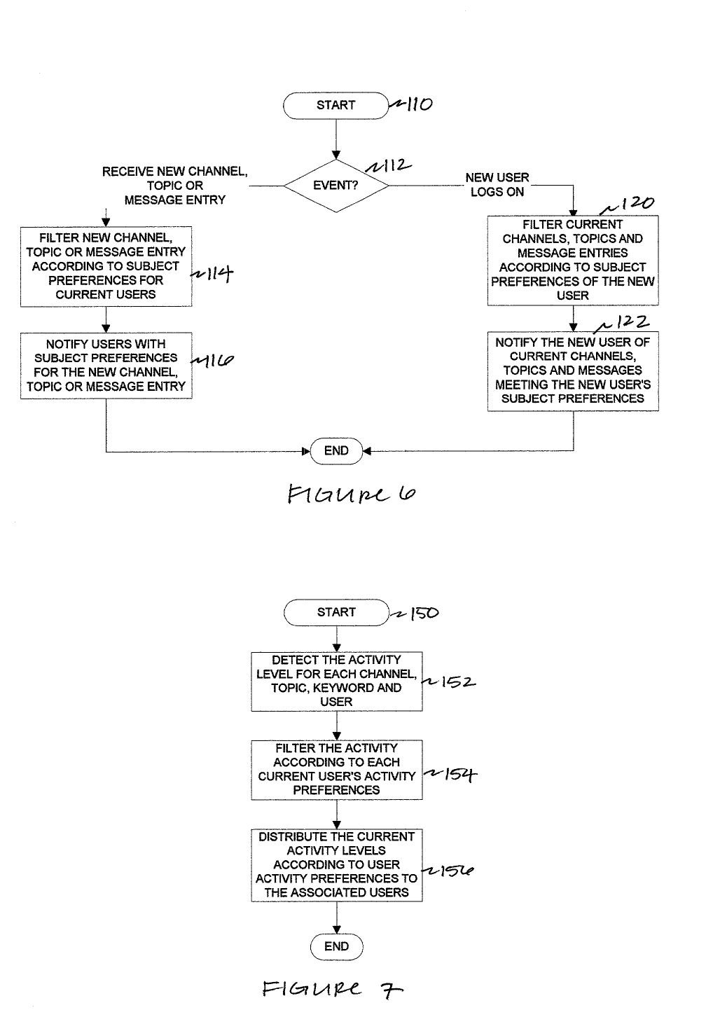

Processor 12 may be a general-purpose processor such as IBM's PowerPC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowcharts of FIGS. 6, 7, and others described herein. Alternatively, the steps of the present invention might be performed by specific hardware components that contain hardwire logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patters of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of nonvolatile media is storage device 18. Volatile media includes dynamic memory such as RAM 14. Transmission media includes coaxial cables, copper wire or fiber optics, including the wires that comprise bus 22. Transmission media can also take the form of acoustic or light waves, such as those generated during radio wave or infrared data communications.

Moreover, the present invention may be downloaded as a computer program product, wherein the program instructions may be transferred from a remote computer such as a server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital data streams. The signals through the various networks and the signals on network link 34 and through communication interface 32, which carry the digital data to and from computer system 10, are exemplary forms of carrier waves transporting the information.

Further, multiple peripheral components may be added to computer system 10. For example, an audio output 28 is attached to bus 22 for controlling audio output through a speaker or other audio projection device. A display 24 is also attached to bus 22 for providing visual, tactile or other graphical representation formats. A keyboard 26 and cursor control device 30, such as a mouse, trackball, or cursor direction keys, are coupled to bus 22 as interfaces for user inputs to computer system 10. In alternate embodiments of the present invention, additional input and output peripheral components may be added.

### Messaging Systems Context

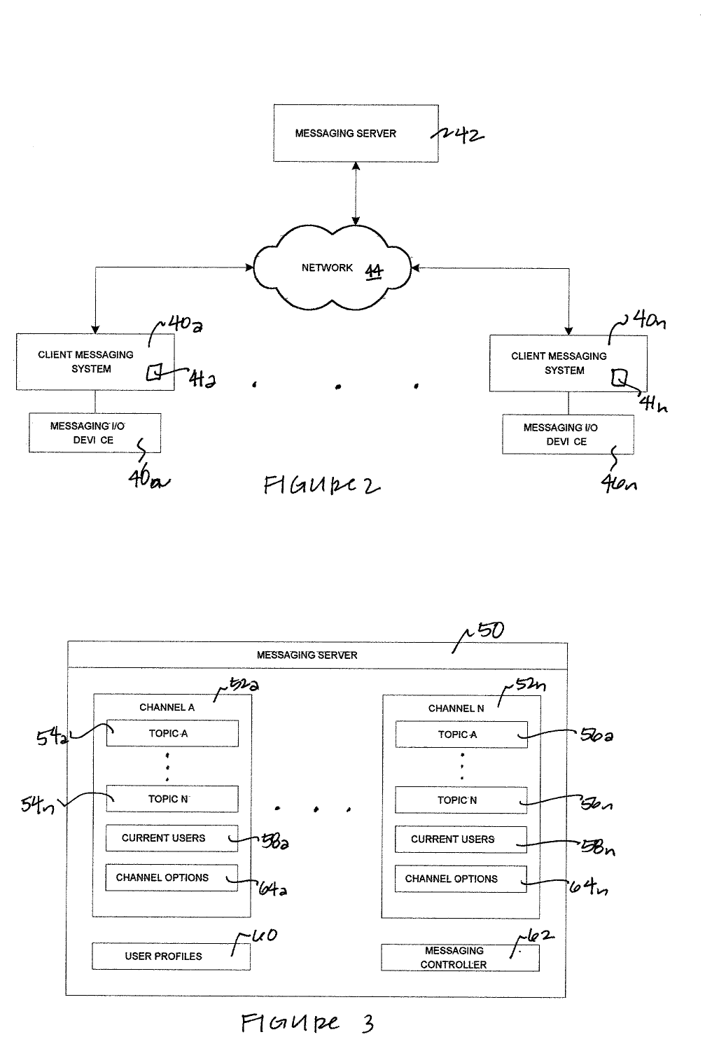

With reference now to FIG. 2, there is depicted a simplified block diagram of a client/server environment in which electronic messaging typically takes place in accordance with the method, system and program of the present invention. The client/server environment is implemented within multiple network architectures. For example, the architecture of the World Wide Web (the Web) follows a traditional client/server modeled environment.

The terms “client” and “server” are used to refer to a computer's general role as a requester of data (the client) or provider of data (the server). In the Web environment, web browsers such as Netscape Navigator typically reside on client messaging systems 40a-40n and render Web documents (pages) served by at least one messaging server such as messaging server 42. Additionally, each of client messaging systems 40a-40n and messaging server 42 may function as both a “client” and a “server” and may be implemented utilizing a computer system such as computer system 10 of FIG. 1. Further, while the present invention is described with emphasis upon messaging server 42 controlling a messaging session, the present invention may also be performed by client messaging systems 40a-40n engaged in peer-to-peer network communications via a network 44.

The Web may refer to the total set of interlinked hypertext documents residing on servers all around the world. A network 44, such as the Internet, provides an infrastructure for transmitting these hypertext documents between client messaging systems 40a-40n and messaging server 42. Documents (pages) on the Web may be written in multiple languages, such as Hypertext Markup Language (HTML) or Extensible Markup Language (XML), and identified by Uniform Resource Indicators (URIs) that specify the particular messaging server 42 and pathname by which a file can be accessed, and then transmitted from messaging server 42 to an end user utilizing a protocol such as Hypertext Transfer Protocol (HTTP). Web pages may further include text, graphic images, movie files, and sounds as well as Java applets and other small embedded software programs that execute when the user activates them by clicking on a link.

Advantageously, in the present invention, a user enters a message via one of messaging input/output (I/O) devices 46a-46n for a messaging session at a client messaging system such as client messaging system 40a. The message entry is transmitted to messaging server 42 in association with a particular channel and further associated with a particular topic within the particular channel. Messaging server 42 then distributes the message entry to client messaging systems 40a-40n where users are participating in the channel. In addition, messaging server 42 compares keywords within the message entry with subject preferences for multiple users and alerts users to the message entry who have subject preferences matching the keywords in the message entry.

In, addition, in the present invention, a user may request a new topic in association with a particular channel via a client messaging system. Messaging server 42 may accept the topic request and then compare the topic request with subject preferences of multiple users. If the topic matches a subject preference of a user, that user is alerted that the subject has been initiated.

Moreover, in the present invention, some users may remain connected to network 44 continuously via one of client messaging systems 40a-40n. However, other users may periodically access network 44 to participate in messaging sessions via messaging server 42. In response to a user logging in to messaging server 42, messaging server 42 preferably compares the current channels, topics, message entries, and users with the user's subject preferences and alerts the user of subjects already in progress.

Messaging server 42 also preferably monitors the activity level of each channel, topic and user participating in a messaging session. The activity levels are filtered according to activity subjects preferred by each user and then transmitted to client messaging systems 40a-40n. The activity subjects preferred by each user may be the same as those included within the user's subject preferences or may include an alternate selection of subjects.

While in the present embodiment messaging server 42 handles transmission of message entries, subject preference notifications activity levels; in alternate embodiments, subject preference notifications and activity levels may be accessible to client messaging systems 40a-40n as files in a directory accessible to a user. In addition, the subject preference notifications and activity levels may be transmitted as e-mail to participants in the messaging session, where the e-mail application functioning on the client messaging system automatically determines that the e-mail contains subject preference notifications and activity levels and outputs the subject preference notifications and activity levels according to user preferences. Moreover, the present invention may utilize a traditional IRC channel for transmitting message entries and a special IRC device channel opened in parallel with the traditional IRC channel for transmitting the subject preference notifications and activity levels among users. Furthermore, other types of messaging systems may be utilized to implement the present invention, as will be understood by one skilled in the art.

Advantageously, the steps performed by message server 42 may also be performed by an application executing in each of client messaging systems 40a-40n, such as client applications 41a-41n, particularly where client messaging systems 40a-40n are communicating in a peer-to-peer network.

Referring now to FIG. 3, there is illustrated a block diagram of one embodiment of a messaging server in accordance with the method, system and program of the present invention. As depicted, messaging server 50 includes a messaging controller 62 that is provided to control the process steps of messaging server 50 as will be further described.

Messaging server 50 also includes multiple channels 52a-52n. Each of channels 52a-52n may represent a separate information path within messaging server 50. Messaging server 50 may have a defined number of channels 52a-52n or may allow users to create new channels as needed.

Each of channels 52a-52n preferably includes multiple topics. In the present example, channel 52a includes topics 54a-54n and channel 52n includes topics 56a-56n. Messaging server 50 may have a finite number of topics that may be pre-defined for each channel or may allow users to created new topics as needed.

In addition, each of channels 52a-52n preferably includes a table of current users 58a-58n. As a user selects to participate in channels 52a-52n, the user's identification is added to the table of current users 58a-58n for that channel. In particular, the table of current users 58a-58n may further specify participation in a selection of topics from among the topics available in a selected channel.

Preferably, as messaging server 50 receives messages, they are stored according to the channel, topic and user and then distributed to each of the users participating in that channel. Further, messaging server 50 may distribute messages to users participating in a channel and more specifically participating in a particular topic or topics within a channel.

Messaging server 50 includes a user profiles database 60 that includes profile information for each user including, but not limited to, a user identification, a name, an electronic mail (e-mail) address, subject preferences, and a user history recorded as the user participates in messaging services. The user identification stored in user profiles 60 during registration is utilized across multiple channels for identifying messages posted by that user. In addition, a user may have a single “screen name” or other textual identifier or multiple “screen names” to identify a single user. Further, user profile information for each user may be stored at each client messaging system and accessed by messaging server for temporary storage in user profiles database 60 while a user is logged into messaging server 50.

In particular, the user history included in user profiles database 60 may include a history of channels and topics that have been initiated by the user or that the user has participated in. Advantageously, messaging server 50 may determine a selection of messaging channels and topics that a user frequently initiates or participates in and provide those topics in the form of selectable outputs such that the user may quickly select from frequently discussed topics. Further, the user may designate topics that are frequently discussed or that the user prefers to have available in a reference list or other selectable output.

In addition, messaging server 50 determines when channels, topics and message keywords are initiated or in progress that match the subject preferences of channel, topic, and keyword preferences included in user profiles database 60. Subject preferences include preferred methods of alerting the user of channels, topics and keywords matching subject preferences that are utilized to transmit subject preference notifications. Further, subject preferences may be distinguished according to the device a user is utilizing to log in to messaging server 50.

Each of channels 52a-52n further includes channel options 64a-64n. Channel options may include, but are not limited to, distinguishing users, distinguishing topics, selecting users to show, selecting topics to show, saving threads by user, saving threads by topic, adding topics, and deleting topics. The channel options for each channel may be pre-determined by message server 50 or may be available for users to define when a channel and/or topic is added. By defining the channel options and more specifically by defining options for individual topics within a channel, the options given to users for customizing outputs may be controlled.

A messaging controller 62 is advantageously a software application executing within messaging server 50 in order to determine the current channels, topics, and keywords that match subjects preferences and alerts users to current channels, topics, and keywords that match subject preferences. Further, messaging controller 62 specifies how each user is alerted to current channels, topics, and keywords according to subject preferences. Alternatively, software executing on the client system may specify how a user is alerted to current channels, topics, and keywords according to subject preferences.

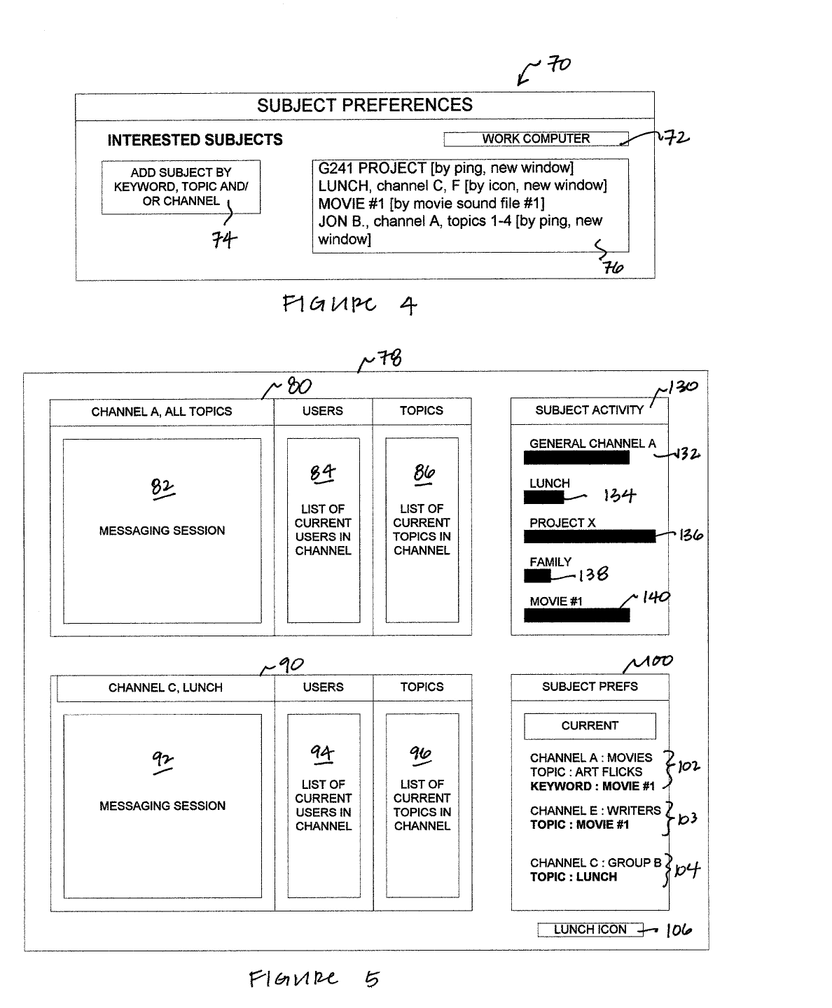

Referring now to FIG. 4, there is illustrated a graphical representation of a subject preference interface in accordance with the method, system and program of the present invention. As depicted, a device block 72 is depicted in a subject preferences window 70 for indicating which device the current subject preferences are set for. In the present embodiment, the device that the subject preferences are set for is titled “work computer”, which preferably references a particular device among multiple devices a user may utilize.

In addition, a selectable button 74 is illustrated within subject preferences window 70. In response to a user selection of selectable button 74, a user is enabled to add or edit preferred subjects by keyword, topic and/or channel. In addition, a user may specify preferences for notification according to subject.

A current preference selection 76 depicts the current subject preferences specified by the user. For example, when the subject “G241 PROJECT” is a current channel, topic, or keyword, the user has specified to be notified by a “ping” and a new window into the associated channel. In another example, when the subject “lunch” is a current topic or keyword in channels C or F, the user has specified to be notified by an icon and a new window into the associated channel.

With reference now to FIG. 5, there is depicted a graphical representation of multiple messaging session windows and current preferred subjects in accordance with the method, system and program of the present invention. As illustrated, a graphical user interface 78 for a particular user is depicted. Within graphical user interface 78, a channel A window 80 is illustrated including a messaging session 82 for channel A, including all topics within channel A. In addition, channel A window 80 includes a list of current users in the channel as depicted at reference numeral 84 and a list of current topics in the channel as illustrated at reference numeral 86. As users request to participate in a channel or are requested by other users to participate in the channel, user identifications are added to the list of current users in the channel. In addition, as topics are added to the channel, those topics are added to the list of current topics in the channel.

Graphical user interface 78 also depicts a channel C window 90. Channel C window 90 includes a messaging session 92 for “lunch” only. In addition, channel C window 90 includes a list of current users in the channel as illustrated at reference numeral 94 and a list of current topics in the channel as depicted at reference number 96. As illustrated, advantageously, a user may participate in multiple messaging sessions at the same time.

A subject preferences window 100 is also illustrated within graphical user interface 78. Subject preference window 100 includes references to multiple messaging sessions pertaining to the subject preferences of a user. In the present example, the user has indicated a preference for the subject “movie #1”. A reference to a first messaging session 102 indicates that the subject “movie #1” is a keyword in a message entry within the channel. A reference to a second messaging session 103 indicates that the subject “movie #1” is a topic in channel E.

In addition, in the present example, the user has indicated a preference for the subject “lunch” in channel C. A reference to a third messaging session 104 indicates that the subject “lunch” is a topic within channel C. In particular, in response to a user selection from first messaging session 102, second messaging session 103, and third messaging session 104, a new window is preferably opened to the portion of the channel referencing the subject preference.

In particular, in addition to subject preferences window 100, additional notifications are preferably illustrated within graphical user interface 78 according to the user's subject preferences as depicted in FIG. 4. For example, since “movie #1” is included in channel A, then “movie sound file #1” is preferably initiated as a notification. In addition, since “lunch” is included in channel C, a lunch icon 106 is included in the display area. In addition, channel C window 90 is opened including only the topic “lunch” from among many topics within channel C.

Additionally, graphical user interface 78 includes an activity window 130 for depicting the activity levels detected according to channel, topic, user, and other criteria that may be designated by the user. By depicting activity levels within activity window 130, a user may track the current levels of participation in particular channels and topics or by particular users of interest utilizing a activity rate. In particular, tracking activity levels is particularly advantageous in that a user may view an indicator of activity without requiring a separate window that displays the actual message entries entered in a particular channel or topic or by a particular user.

In particular, the activity depicted in activity window 130 may include subject preferences for a user, however may also include channels, topics, and users that are selected by the user independent of subject preferences. For example, a user may drag and drop channel names, users and topics into activity window 130 for tracking. In an alternate method, a user may select from a directory of channels, topics, keywords, and users to be included in activity window 130. In addition, the activity depicted in activity window 130 may include, but is not limited to, number of entries per minute, most recently used, least recently used, bytes per minute, and other criteria for measuring activity that may be selected by the user. A user may select one of the indicators of activity within activity window 130 in order to request additional activity information, adjust preferences for the activity subject and/or initiate a new window for the subject.

In the present example, first, a general activity indicator 132 is illustrated representing the general activity level of message entries for channel A. In addition, the activity for topics “lunch” and “project X” are indicated respectively by lunch activity indicator 134, project X activity indicator 136. “Family” is a title the user has associated with a group of user identifications. In the present example, activity by users in the group “family” is indicated by family activity indicator 138.

Activity for topic “movie #1” in the present example provides a single cumulative indicator of activity across multiple channels. In particular, movie #1 indicator 140 references the cumulative channel activity for movie #1. Advantageously, if a user selects movie #1 indicator 140, the user may view the activity separated according to channel. In addition, while in the present embodiment, the activity for each instance of a topic is cumulatively depicted, in alternate embodiments, activity for a single topic discussed in multiple channels may be illustrated separately.

In particular, in representing activity levels, a graphical indicator such as those depicted in activity window 130 may be utilized where a length and size of a graphical bar increases to indicate increased activity. In addition, graphical indicators may be utilized including, but not limited to, translucency, light-emitting diode (LED) bars, and sorting according to user-defined criteria. In particular, graphical indicators may be sorted according to number of entries, number of bits, most recently used, and other criteria.

Referring now to FIG. 6, there is illustrated a high level logic flowchart of a process and program for notifying users when messaging sessions include subject preferences in accordance with the method, system, and program of the present invention. As depicted, the process starts at block 110 and thereafter proceeds to block 112. Block 112 illustrates a determination as to which event occurred when an event occurs. If a new channel, topic or message is received, then the process passes to block 114. If a user logs on to the messaging server, then the process passes to block 120.

Block 114 depicts filtering the new channel, topic or message according to the subject preferences of current users. In particular, new channels, topics, and messages may be filtered further according to channel options such that each user will only be notified of current subjects accessible to each user. Next, block 116 illustrates notifying users with subject preferences for the new channel, topic or message, and the process ends.

Block 120 illustrates filtering the current channels, topics and messages according to subject preferences of the new user. Next, block 122 depicts notifying the new user of channels, topics or messages containing subjects preferred by the new user, and the process ends.

With reference now to FIG. 7, there is illustrated a high level logic flowchart of the process and program for detecting and distributing activity level notifications in accordance with the method, system, and program of the present invention. As depicted, the process starts at block 150 and thereafter proceeds to block 152.

Block 152 illustrates detecting the activity according to multiple factors for each channel, topic, keyword and user. Next, block 154 depicts filtering the activity according to each current user's activity preferences. In addition, the activity may be filtered according to activity preferences for system administrators and other users enabled to access the messaging system while not participating in messaging sessions. For example, a manager may be authorized to monitor the activity for particular employees such that the manager may join messaging sessions where particular employees are particularly active. Thereafter, block 156 illustrates distributing the current activity levels to the current users according to each user's preferences, and the process ends.

While the invention has been particularly shown and described with reference to a preferred embodiment, it will be understood by those skilled in the art that various changes in form and detail may be made therein without departing from the spirit and scope of the invention.

What is claimed is:

1. A method for notifying users of subject preferences across a plurality of messaging sessions, said method comprising the steps of:
filtering a plurality of current messaging sessions according to subject preferences for a user; and
notifying said user of a selection from among said plurality of current messaging sessions correlating to said subject preferences for said user, such that said user is enabled to monitor conversations comprising said subject preferences across said plurality of current messaging sessions.

2. The method for notifying users of subject preferences according to claim 1, said method further comprising the step of:
filtering said plurality of current messaging sessions and notifying said user from a messaging server communicatively connected to a plurality of client messaging systems, wherein a particular client messaging system from among said plurality of client messaging systems is accessible to said user.

3. The method for notifying users of subject preferences according to claim 1, said method further comprising the step of:
filtering said plurality of current messaging sessions and notifying said user from a particular client messaging system communicatively connected to a plurality of client messaging systems.

4. The method for notifying users of subject preferences according to claim 1, said step of filtering a plurality of current messaging sessions further comprising the step of:
filtering a new channel added as a new messaging session to said plurality of current messaging sessions according to subject preferences for a user.

5. The method for notifying users of subject preferences according to claim 1, said step of filtering a plurality of current messaging sessions further comprising the step of:
filtering a new topic added to a channel from among said plurality of current messaging sessions according to subject preferences for a user.

6. The method for notifying users of subject preferences according to claim 1, said step of filtering a plurality of current messaging sessions further comprising the step of:
filtering a new keyword added as a new message entry to a particular messaging session from among said plurality of current messaging sessions according to subject preferences for a user.

7. The method for notifying users of subject preferences according to claim 1, said step of filtering a plurality of current messaging sessions further comprising the step of:
filtering said plurality of current messaging sessions according to subject preferences for a user added to said plurality of current messaging sessions.

8. The method for notifying users of subject preferences according to claim 1, said step of filtering a plurality of current messaging sessions further comprising the step of:
filtering said plurality of messaging sessions according to subject preferences for a plurality of users participating in at least one from among said plurality of messaging sessions.

9. The method for notifying users of subject preferences according to claim 1, said step of notifying said user of a selection from among said plurality of current messaging sessions, further comprising the step of:
notifying said user of said selection from among said plurality of current messaging sessions utilizing an output indicated in notification preferences for said user.

10. The method for notifying users of subject preferences according to claim 1, said method further comprising the steps of:
detecting an activity level associated with said selection from among said plurality of current messaging sessions; and
notifying said user of said activity level.

11. The method for notifying users of subject preferences according to claim 10, said step of detecting an activity level associated with said selection from among said plurality of current messaging sessions further comprising the step of:
detecting said activity level for at least one from among a channel, a topic, or a user within said selection from among said plurality of current messaging sessions.

12. The method for notifying users of subject preferences according to claim 10, said step of detecting an activity level associated with said selection from among said plurality of current messaging sessions further comprising the step of:
detecting said activity level comprising at least one from among a number of bytes within a particular time period, a number of message entries within a particular time period, and a time period since a message entry was last entered.

13. A system for notifying users of subject preferences across a plurality of messaging sessions, said system comprising:
a messaging server communicatively connected to a network;
said messaging server further comprising:
means for filtering a plurality of current messaging sessions at said messaging server according to subject preferences for a user; and
means for notifying said user from said messaging server of a selection from among said plurality of current messaging sessions correlating to said subject preferences for said user, such that said user is enabled to monitor conversations comprising said subject preferences across said plurality of current messaging sessions.

14. The system for notifying users of subject preferences according to claim 13, said means for filtering a plurality of current messaging sessions further comprising:
means for filtering a new channel added as a new messaging session to said plurality of current messaging sessions according to subject preferences for a user.

15. The system for notifying users of subject preferences according to claim 13, said means for filtering a plurality of current messaging sessions further comprising:
means for filtering a new topic added to a channel from among said plurality of current messaging sessions according to subject preferences for a user.

16. The system for notifying users of subject preferences according to claim 13, said means for filtering a plurality of current messaging sessions further comprising:
means for filtering a new keyword added as a new message entry to a particular messaging session from among said plurality of current messaging sessions according to subject preferences for a user.

17. The system for notifying users of subject preferences according to claim 13, said means for filtering a plurality of current messaging sessions further comprising:
means for filtering said plurality of current messaging sessions according to subject preferences for a user added to said plurality of current messaging sessions.

18. The system for notifying users of subject preferences according to claim 13, said means for filtering a plurality of current messaging sessions further comprising:
means for filtering said plurality of messaging sessions according to subject preferences for a plurality of users participating in at least one from among said plurality of messaging sessions.

19. The system for notifying users of subject preferences according to claim 13, said means for notifying said user of a selection from among said plurality of current messaging sessions, further comprising:
means for notifying said user of said selection from among said plurality of current messaging sessions utilizing an output indicated in notification preferences for said user.

20. The system for notifying users of subject preferences according to claim 13, said system further comprising:
means for detecting an activity level associated with said selection from among said plurality of current messaging sessions; and
means for notifying said user of said activity level.

21. The system for notifying users of subject preferences according to claim 20, said means for detecting an activity level associated with said selection from among said plurality of current messaging sessions further comprising:
means for detecting said activity level for at least one from among a channel, a topic, or a user within said selection from among said plurality of current messaging sessions.

22. The system for notifying users of subject preferences according to claim 20, said means for detecting an activity level associated with said selection from among said plurality of current messaging sessions further comprising:
means for detecting said activity level comprising at least one from among a number of bytes within a particular time period, a number of message entries within a particular time period, and a time period since a message entry was last entered.

23. A program for notifying users of subject preferences across a plurality of messaging sessions, residing on a computer usable medium having computer readable program code means, said program comprising:
means for filtering a plurality of current messaging sessions according to subject preferences for a user; and
means for enabling a notification to said user of a selection from among said plurality of current messaging sessions correlating to said subject preferences for said user, such that said user is enabled to monitor conversations comprising said subject preferences across said plurality of current messaging sessions.

24. The program for notifying users of subject preferences according to claim 23, said means for filtering a plurality of current messaging sessions further comprising:
means for filtering a new channel added as a new messaging session to said plurality of current messaging sessions according to subject preferences for a user.

25. The program for notifying users of subject preferences according to claim 23, said means for filtering a plurality of current messaging sessions further comprising:
means for filtering a new topic added to a channel from among said plurality of current messaging sessions according to subject preferences for a user.

26. The program for notifying users of subject preferences according to claim 23, said means for filtering a plurality of current messaging sessions further comprising:
means for filtering a new keyword added as a new message entry to a particular messaging session from among said plurality of current messaging sessions according to subject preferences for a user.

27. The program for notifying users of subject preferences according to claim 23, said means for filtering a plurality of current messaging sessions further comprising:
means for filtering said plurality of current messaging sessions according to subject preferences for a user added to said plurality of current messaging sessions.

28. The program for notifying users of subject preferences according to claim 23, said means for filtering a plurality of current messaging sessions further comprising:
means for filtering said plurality of messaging sessions according to subject preferences for a plurality of users participating in at least one from among said plurality of messaging sessions.

29. The program for notifying users of subject preferences according to claim 23, said means for notifying said user of a selection from among said plurality of current messaging sessions, further comprising:
means for notifying said user of said selection from among said plurality of current messaging sessions utilizing an output indicated in notification preferences for said user.

30. The program for notifying users of subject preferences according to claim 23, said program further comprising:
means for detecting an activity level associated with said selection from among said plurality of current messaging sessions; and
means for notifying said user of said activity level.

31. The program for notifying users of subject preferences according to claim 30, said means for detecting an activity level associated with said selection from among said plurality of current messaging sessions further comprising:
means for detecting said activity level for at least one from among a channel, a topic, or a user within said selection from among said plurality of current messaging sessions.

32. The program for notifying users of subject preferences according to claim 30, said means for detecting an activity level associated with said selection from among said plurality of current messaging sessions further comprising:
means for detecting said activity level comprising at least one from among a number of bytes within a particular time period, a number of message entries within a particular time period, and a time period since a message entry was last entered.

33. A user interface method for specifying messaging session subject preferences, said method comprising:
graphically displaying a plurality of selectable items representing a plurality of current messaging sessions matching messaging session preferences for a user within a display area; and
responsive to a selection from among said plurality of selectable items, initiating a graphical display of a matching messaging session within said display area.

34. A user interface for a display of specified messaging session subject preferences, said interface comprising:
a plurality of graphically displayed selectable items representing a plurality of current messaging sessions matching messaging session preferences for a user within a display area; and
means for initiating a graphical display of a matching messaging session within said display area, in response to a user selection from among said plurality of selectable items.
